(19) United States
(12) Patent Application Publication
(10) Pub. No.: US 2011/0268545 A1
(43) Pub. Date: Nov. 3, 2011

(54) VEHICLE MOUNTED LIFT FOR HANDICAPPED ACCESS

(76) Inventor: Mohammad Fakhrizadeh, Nashua, NH (US)

(21) Appl. No.: 12/963,706

(22) Filed: Dec. 9, 2010

Related U.S. Application Data
(60) Provisional application No. 61/328,735, filed on Apr. 28, 2010.

(51) Int. Cl. A61G 7/14

(52) U.S. Cl. 414/543; 5/87.1

(57) ABSTRACT

An apparatus is provided for lifting and transferring a physically incapacitated person into and out of a vehicle, bed, bathtub, and the like. The apparatus comprises a mounting bracket, a vehicle mounting adaptor, a universal mounting adaptor, which are configured to removably couple to the hinges of a vehicle, a bathroom wall, or a bed frame, a lifting member removably and pivotally coupled to the mounting bracket, configured to pivot vertically and horizontally, pivotally and removably coupled at a proximal end to an extension arm and configured to lift, move and support a disabled person by means of a sling receiving member which is removably and pivotally disposed at a distal end of the lifting member, a jack actuating the lifting member, and a controller whereby the jack is controlled. The provided mounting adaptors expand and facilitate the broad use of the apparatus.

### RELATED APPLICATIONS

This application claims the benefit of U.S. provisional patent application No. 61/328735, filed Apr. 28, 2010, which is herein incorporated in its entirety by reference.

### TECHNICAL FIELD

The invention relates to a universal lift for assisting a disabled person in moving from one place to another. More particularly, the invention relates to a lift for placing a disabled person in a vehicle having a universal mounting system configured for mounting the lift on the front and rear door hinges of a variety of makes and models of vehicles. The universal lift of the present invention may also be used to place a disabled person in a bed, bathtub and other seated positions.

### BACKGROUND

There are many people in every society, who are the victims of accidents, or as a consequence of contracting a disease, lose their mobility. For these people, and the people around them, getting out of their home and to a destination is a major task. A disabled person may use a wheelchair to get around at home, but to travel uses a vehicle. One obstacle lies in the means of moving disabled individuals from one place to another and this may be a grueling or a costly task.

Various devices have therefore been designed and patented for transferring physically incapacitated individuals between vehicles and wheelchairs. Certain prior art lifting apparatuses may not be readily disassembled, or are too bulky and cannot be stored in any vehicle, thus creating a need for availability of the specific vehicle. In addition, they have limited maneuvering abilities. Some prior art devices also suffer from certain drawbacks and deficiencies. For example, the door checks will not allow for most vehicle doors to open wide enough to use some lifters because they do not have enough flexibility to compensate for the lack of space between a fully opened door and the seat. In employing other prior art devices, a vehicle must be customized, which is costly, and many of these devices are incapable of being installed on all vehicles.

What is needed, therefore, is a means to eliminate the disadvantages of the existing methods of hoisting and transferring physically incapacitated individuals between a wheelchair and a vehicle. The use of a universally installable apparatus that may easily be mounted on a variety of makes and models of vehicle, while requiring minimal effort from a lay person for assisting and performing the task safely and comfortably, is highly desirable.

### SUMMARY

Hence, this invention not only provides a practical solution to eliminate the explained problem, but it is compact and may be stored under the wheelchair. In addition, the same apparatus may fulfill other hoisting and lifting needs at home or in the office.

One embodiment of the present invention provides a portable, lightweight apparatus which can be packaged in a 50 cm×33 cm×12.5 cm case and be stored under a wheelchair, is designed to mount easily and quickly on a variety of vehicles using the vehicle door hinges and rocker panel as the mounting base. After finishing a task, the apparatus may be disengaged, removed from the vehicle, and repacked as easily as it was mounted with nothing attached to the vehicle.

As a result, the disabled person does not need to have an expensive, specially customized vehicle. Indeed, these people do not even need to own a vehicle and may use a taxi. The disabled individual may own a vehicle of their choice, including a sports car or a small, compact car.

According to another embodiment, the lifting member of the lifting apparatus is universal. It may be mounted on all vehicle mounting members as the mounting members are adaptable to install on different makes and models of vehicles for day to day use. As a result, the need for a specific vehicle or driver will be eliminated. In addition, the lifting member may be installed for home or office use.

There is a need to point out that in some vehicle models, the unique position of the door-checks or the extraordinary sizes of the hinges may require a specific mounting bracket. Therefore, anyone assisting a disabled person using their own vehicle may need to have a specific mounting bracket, which weighs less than 5 lbs. A taxi may then have its own mounting bracket for use with disabled customers.

Even though every year governments across the globe spend millions of dollars toward making the transportation system more “disabled friendly”, the cost of transportation for this group of people are still substantially high. Some of this cost could be eliminated if governments would agree on regulating the size of vehicle door hinges to be universal within in a range. Then, one mounting bracket may fit on all makes and models.

In another embodiment, the assistance of only one person is needed to use the present invention. This assistant could be almost anyone, for example, a mother who wants to take her family member out of the home for a ride around town, a teenager that wishes to take a family member to any destination, such as going to a doctor, or even taking friends to a party. The result gives the disabled individual a better quality of life.

In another embodiment, several pairs of universal mounting adaptors equipped with a 12V DC power supply may be installed around the house, e.g. the bathroom, near the bed, etc., so that the same apparatus may be used to lift the person in other situations.

In another embodiment, the action of lifting is done by a 12V DC jack. The jack will get its power from a cigarette lighter of a vehicle or a 12 volt direct current power supply. The action of this jack is controlled via an electrical control unit.

In one embodiment, the lifter may hold an umbrella when transporting of the disabled individual is taking place on a rainy day.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS AND PHOTOS

FIG. 1A is a block diagram illustrating the top view of a mounting member configured in accordance with one embodiment of the present invention.

FIG. 1B is a block diagram illustrating the top view of an adjustable hook configured in accordance with one embodiment of the invention.

FIG. 1C is a block diagram illustrating the side view of a mounting member configured in accordance with one embodiment of the invention.

FIG. 2A is a block diagram illustrating the front view of a mounting bracket receiver member of a vehicle mounting adapter configured in accordance with one embodiment of the invention.

FIG. 2B is a block diagram illustrating the side view of a vehicle mounting adapter section configured in accordance with one embodiment of the invention.

FIG. 2C is a block diagram illustrating the top view of a mounting bracket receiver member of a vehicle mounting adapter configured in accordance with one embodiment of the invention.

FIG. 3A is a block diagram illustrating the side view of the inner shell of the lower arm to show the arrangements of the mechanical level switch actuators in accordance with one embodiment of this invention.

FIG. 3B is a block diagram illustrating the top view of a sling receiving member in accordance with one embodiment of this invention.

FIG. 3C is a block diagram illustrating a maximum down limit switch assembly.

FIG. 3D is a block diagram illustrating a maximum up limit switch assembly.

FIG. 3G is a block diagram illustrating a side view of a lifting member configured in accordance with one embodiment of the present invention.

FIG. 4 is a block diagram illustrating an expanded side view of a jack.

Photo 1 is a photograph of a vehicle hinge of a BMW automobile.

Photo 2 is a photograph of a vehicle hinge of a Toyota Camry.

Photo 3 is a photograph of a mounting bracket disposed on a vehicle hinge as in Photo 1.

Photo 4 is an installation of one embodiment of the present invention in a vehicle as in Photo 1.

Photo 5 is a photograph of a vehicle mounting adapter mounted on a vehicle hinge as in Photo 2.

Photo 6 is a photograph of a vehicle mounting adapter/mounting bracket/lifting section.

Photo 7 is a photograph of an vehicle mounting adapter/mounting bracket/lifting section/extension arm disposed on a vehicle hinge as in Photo 2.

Photos 8-10 are installations of one embodiment of the present invention in a vehicle as in Photo 2 shown on various doors of a Toyota Camry.

### DETAILED DESCRIPTION

One embodiment of the present invention provides a durable structure comprised of a mounting bracket, a lifting member, and two mounting adapters, they are all configured to be detachable without tools.

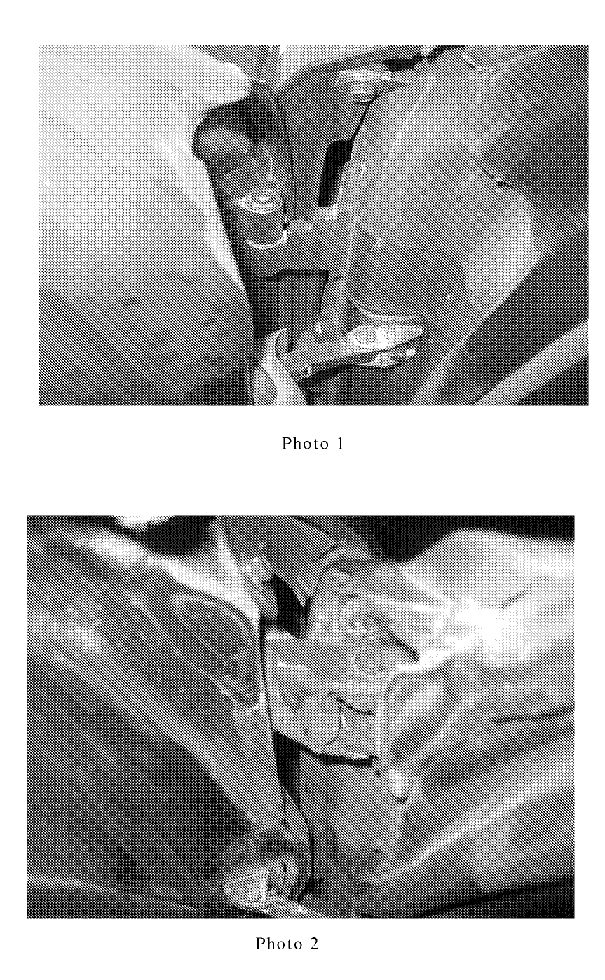

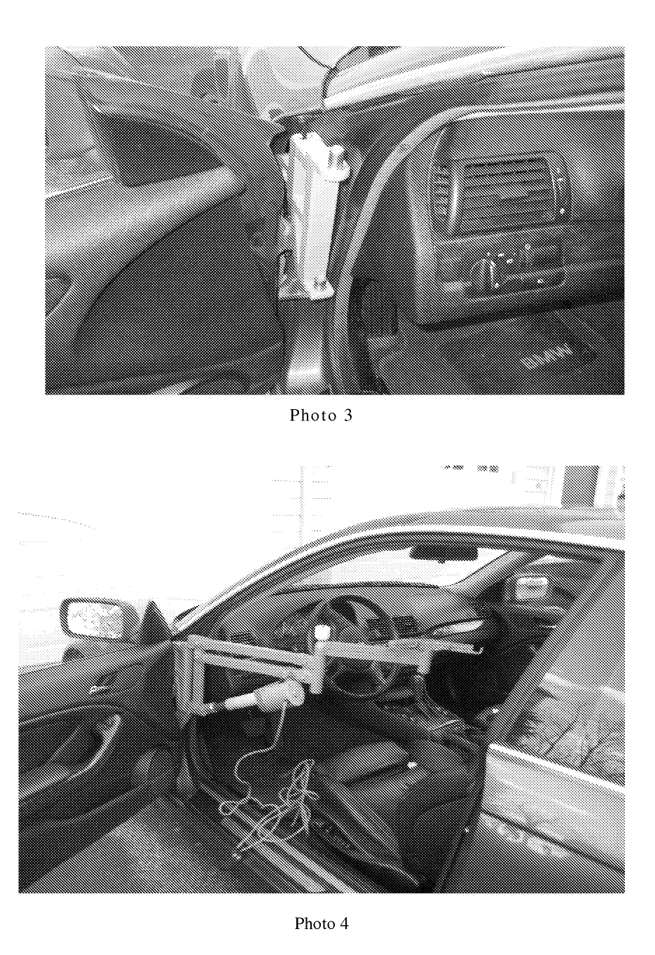

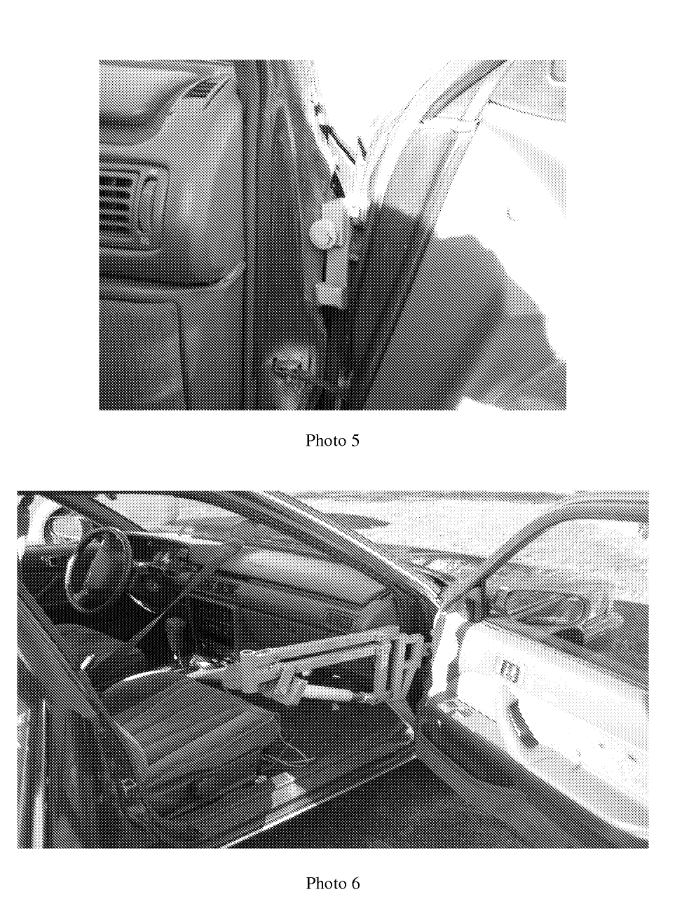

A side view of a vehicle mounting bracket configured with one embodiment of this invention is illustrated in FIG. 1C. It attaches to a vehicle via the door hinges, either directly (if the bases for the door hinges are regular bend, such as most BMW hinges shown in Photo 1), or first install the vehicle mounting adaptor illustrated in FIG. 2B (if the bases for the door hinges are made of a kind of formed plates, such as Toyota door hinges shown in Photo 2), then the mounting bracket would be mounted on the vehicle mounting adapter.

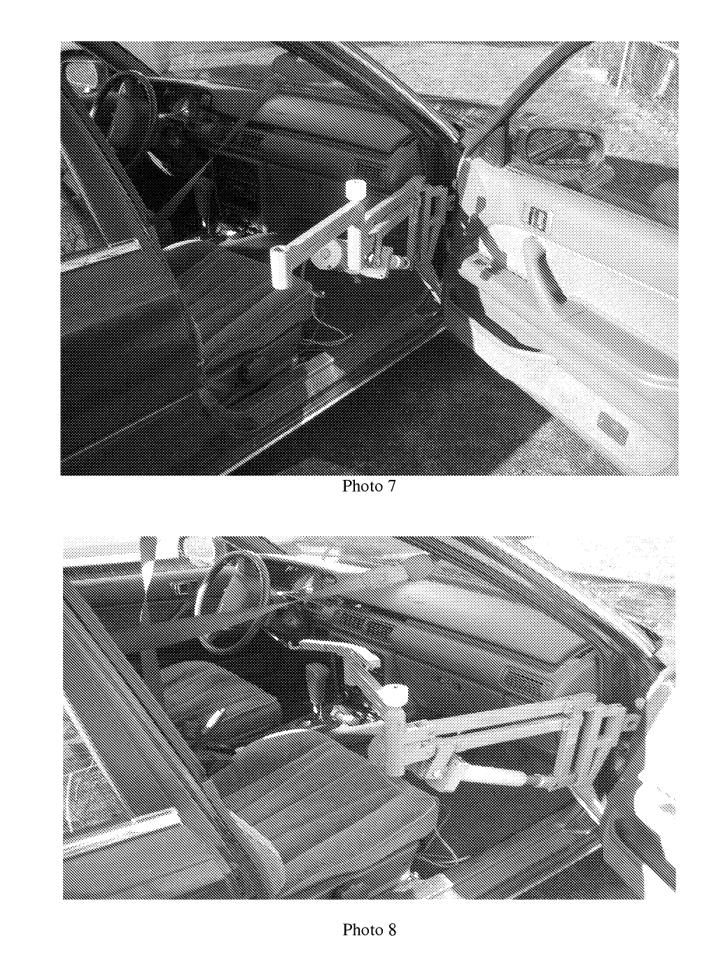

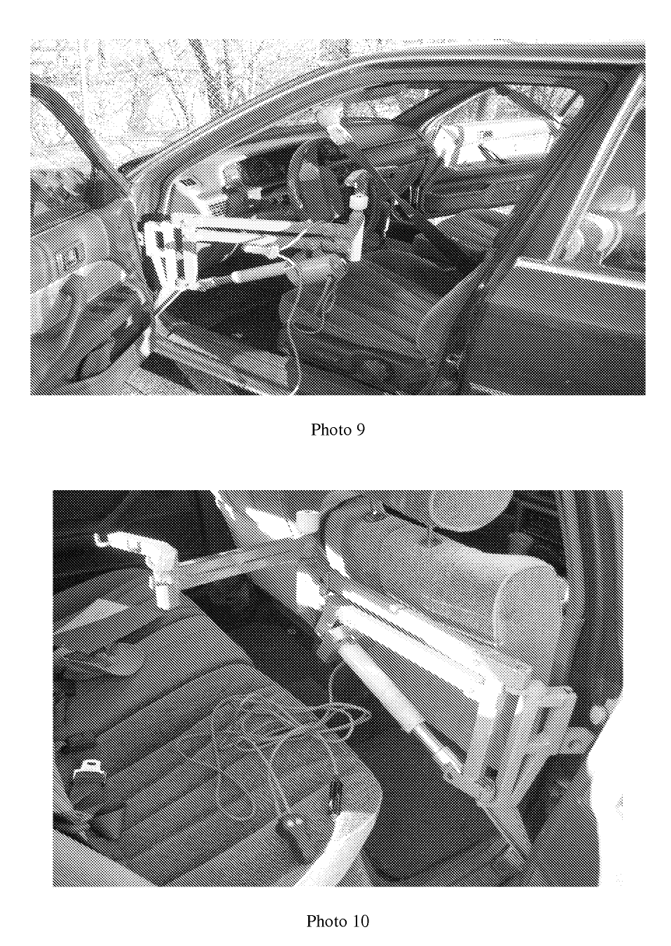

Referring to FIG. 1C, a mounting bracket has a special shape to clear a vehicle door check. It comprises a frame 26, an adjustable hook 18, and a configured weight distributing structure 32. On one side of the frame 26, are permanently attached axis 10 and 30 for receiving the bores 98, 140 of FIG. 3G. On the opposite side, at the base, is a stationary hook 28 of FIGS. 1A, 1C. Since various vehicles of different makes and models have different distances between their door hinges, a configured adjustable hook 18 of FIGS. 1B, 1C is employed to compensate for the differences. This adjustable hook 18 is T-shaped 34 of FIG. 1B at one end, hence, for adjusting purposes, can slide up and down in a configured T-slot 16 of FIGS. 1A, 1C. The grooves, 20 and 50 are covered with a resilient rubber or other material to prevent scratches to the hinges. Two holes 14 and 24 are provided to accept and lock an umbrella shaft in the position. To remove the umbrella, the release button 12 is pressed. FIG. 1A shows the holes 14 and 24 do not have the same centerline, in order to prevent the rotation of the umbrella as the result of a possible wind force. The frame 26 and the adjustable hook 18 are made of drop forged alloy steel or die cast-high strength aluminum alloy such as 7075. The axis 10, 30 are made of a rust proof high strength alloy steel.

Referring to FIG. 1C again, said configured weight distributing structure 32, comprises a collar 48, a swivel 44, a bar knob 42 a clevis 40, an eye bracket 38, an Acme spindle 35, which has a soft touch knob 34 at one end, and a swivel pad 36 at the other end to ensure seating on uneven surfaces of a rocker panel. The bottom of the swivel pad 36 is covered with a rubber 37 or other resilient material for marring, damage, and scratch prevention. The collar 48 has a clamping knob 46, and can move up and down on the lower portion of the frame 26. The collar 48, the locking swivel 44, the clevis 40, and the Acme spindle 35 are to compensate for the differences of the distance between the lower door hinge and the top of a rocker panel of one vehicle with respect to another, and are made of drop forged alloy steel or die cast-high strength aluminum alloy, such as 7075. This bracket weighs about 5 lb.

A side view of an vehicle mounting adapter is shown in FIG. 2B. It comprises a clamp 56 and a mounting bracket receiving member 54 which are made of drop forged alloy steel or die cast-high strength aluminum alloy, such as 7075, and weighs only a few ounces. The front view of the mounting bracket receiving member is illustrated in FIG. 2A. The clamp 56 has an Acme spindle which swivels into the mounting bracket receiving member 54 at a point 52 of FIG. 2A. At the other end of the Acme spindle is a bar knob 62. The clamp and the mounting bracket receiving member have two steps 58 and 60 respectively. The distance between the steps 58 and 60 is provided to clear the head of the hinge pin.

FIG. 2C is the top view of the mounting bracket receiving member 54 and illustrates a hollow space 64 and a hook receiving bracket 66. A pair of mounting bracket receiving member 54 may be installed on any wall as needed, e.g. next to a toilet bowl, a bathtub, or a bed.

FIG. 3G illustrates the side view of a lifting member of the apparatus. It comprises a lifting section 127, an extension arm 72, and a sling receiving member 70, in accordance with one embodiment of this invention.

Referring to FIG. 3G, the lifting section 127 comprises a frame 136, an extension arm receiving bracket 118, an upper arm 101, a lower arm 131, and a jack 128.

The frame 136 of FIG. 3G has two bores at the distal side 98 and 140 to facilitate the installation and pivoting action on mounting bracket FIG. 1C, in accordance with one embodiment, and at the opposite side has three devises 100, 134, and 138.

The extension arm receiving bracket 118 of FIG. 3G has a bore 116 for hosting the shaft 76 of the extension arm, in accordance with one embodiment, and/or two devises, 110, 122 and two level switch assemblies, 112, 114 in accordance with another embodiment of this invention.

The upper arm 101 of FIG. 3G comprises an outer shell 102 and an inner shell 108 where one slides into the other to facilitate the extension of the arm up on demand. Its length varies by aligning the only hole provided in the outer shell 102 with either one the holes provided in the inner shell 108 (such as the hole 106), then inserting a quick release pin 104 in the aligned holes. The outer shell 102 is hinged to the clevis 100 of the frame 136 and the inner shell 108 is hinged to the clevis 110 of bracket 118.

The lower arm 132 is also telescopic, just as the upper arm 101. It must be kept in mind, however, that the length of these two arms must always be equal and the quick release pin 125 is used to lock the shells in the position. The outer shell 102 hinged to the clevis 134 of the frame 136 and the inner shell 108 is hinged to the clevis 122 of bracket 118. The outer shell 132, at the nearest point to the quick release pin 125, has a clevis 126 to pivotally receive the jack 128. The other end of the jack 128 is hinged to the clevis 138 of the frame 136.

FIG. 3A shows the side view of the inner shell 88 of FIG. 3G, at the end in which it couples with the clevis 122 of FIG. 3G. It has two teeth 84 and 86 to trigger their corresponding limits switches 79 of FIG. 3D and 83 of FIG. 3C respectively when either limit is reached. This inner shell 88 has three holes 124 of FIGS. 3A, 3G for the purpose of adjusting the length. The shells are made of steel or other high strength profiles of different shapes.

FIG. 3G shows a set up of the limit switch assemblies 112 and 114, although they can be made of other shapes and positioning. The maximum down limit switch and the maximum up limit switch assemblies are shown in FIGS. 3C and 3D respectively.

Referring to FIG. 3C, a maximum down limit switch assembly 114 consists of a mounting adjusting bracket 82, a limit switch 83, a mounting hole 81, and a mounting adjusting hole 80.

Referring to FIG. 3D, a maximum up limit switch assembly 112 consists of a mounting adjusting bracket 78, a limit switch 79, a mounting hole 76, and a mounting adjusting hole 77.

The extension arm 72 at one end has a shaft 76 with a proper length and diameter. At a place above the shaft 76 is a handle 73 to ease the transporting operation. At the other end of the extension arm 72 is a bore 74 with bushings, which hosts a sling receiving member 70.

The sling receiving member 70 comprises a crescent shape sling receiving element 69 (also a top view is shown in FIG. 3B) secured to shaft 71 at its center using bolt 68 and a lock washer 68A. The sling receiving member 70 may be mounted on the extension arm 72 from the top as shown in FIG. 3G as well as installed from the bottom using the same bore 74 of FIG. 3G, then a soft touch knob with stud 75 is used to secure it from the top. This feature provides additional vertical displacement of a subject. Referring to FIG. 3B, holes 90-96 accept sling hooks.

The lifting section 127 of FIG. 3G weighs about 15 lbs. The frame 136, the bracket 118, the extension arm 72, and the sling receiving members are made of drop forged alloy steel or die cast-high strength aluminum alloy, such as 7075. The shells are made of high strength aluminum alloy, such as 7075 profiles. All the shafts and clevis pins are made of high strength and rust resistant alloy steel.

The jack 128 of FIG. 3G runs on 12V DC power via a cigarette lighter receptacle of a vehicle or a 12V DC power supply at a home or office. It comprises a motor 146 of FIG. 4, a reducer gear box, which its exploded-side view is shown in FIG. 4, an electrical control unit 142 of FIG. 4 with the ability to reverse the direction of the rotation to provide jacking mechanism. These parts may be found in an electrical car jack that may be purchased from the market, with the exception of some parts of the lifting mechanism and the maximum up or the maximum down limit switches.

An electrical car jack typically facilitates lift due to the pulling action of an Acme nut toward the gear box on its Acme spindle. Also in the electrical car jack, the spindle is exposed and is always greasy, but for the purpose of this lifting apparatus, a pushing action of an Acme spindle and a clean (grease free) environment is required. The limit switches of the jack also needed to be adapted and positioned in a proper place as illustrated and explained earlier.

The parts used in the lifting apparatus from the electrical car jack shown in FIG. 4 are as follows: the control unit 142 and its connecting wires 141, 144, the motor 146 and its gear 150, the gearbox casing 148, bearings 174, 172, 154, the reducer gear 152, the gear cover 156, the cover bolts 158-170, the thrust bearing 184, the key 180, the bearing 192, the internal retaining ring 194, and the spindle gear 196. The replaced or added parts are the shaft 186, the key way 188, the external retaining ring groove 182, the Acme spindle 190, the external retaining ring 198, the Acme round nut 166, the hollow aluminum tube 164, and the cap 162 with an eye 163. When the jack is in its extended position, the spindle is covered by the Teflon® tube 130 of FIG. 3G.

When all the parts, members and sections are assembled and attached to a vehicle or any other location, the combination of durability, lifting and pivoting ability provides a great three dimensional maneuvering power to this machine enabling a disabled person to be transferred between any two places.

For further clarification, if needed, Photos 1 through 10 depict the sections, members, and parts and their functions in the apparatus described therein.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. For example, the control unit may be wireless or voice activated; cross sections of upper, lower, and/or extension arms may be square, rectangular, circle, oval, etc.; the frame may be made of steel profile or other rugged material, etc.; and level switches may be replaced with magnetic or other sensing units.

Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

What is claimed is:

1. A universal-lift apparatus for invalid access, said lift apparatus comprising:
a mounting member;
a lifting member, said lifting member being configured to be pivot vertically and horizontally at a distal end removably and pivotally disposed on said mounting member and configured to lift, move and support an invalid by means of a sling receiving member removably and pivotally disposed at a proximal end;
a jack, the jack actuating said lifting member; and
a controller for controlling said jack.

2. The apparatus according to claim 1 wherein said mounting member further comprises:
a vehicle mounting adaptor;
a universal mounting adaptor; and
a mounting bracket, said mounting bracket at a proximal side being configured to removably and pivotally accept said distal end of said lifting member and at a distal side removably disposed on a vehicle hinge or on said adaptors, said mounting bracket further comprising an umbrella receiving member disposed proximate to said mounting bracket wherein said invalid is shielded from the elements.

3. The apparatus according to claim 2 wherein said vehicle mounting adaptor at a distal side is configured to be removably disposed on said vehicle hinge and at a proximal side to removably accept said distal side of said mounting bracket.

4. The apparatus according to claim 2 wherein said universal mounting adaptor at a distal side is configured to be secured to a surface or a frame and at a proximal side to removably accept said distal side of said mounting bracket.

5. The apparatus according to claim 1 wherein said lifting member comprises a lifting segment, said lifing segment removably and pivotally proximal at a distal end disposed on said mounting member and an extension arm removably and pivotally disposed between said lifting segment and said sling receiving member.

6. The apparatus according to claim 1 wherein said jack is actuated by a direct current motor.

7. The apparatus according to claim 6 wherein said direct current motor is selected from the group consisting of a 12 volt motor and a 24 volt motor.

8. The apparatus according to claim 1 further comprising at least one limit switch coupled to a power supply disposed on said lifting segment wherein said limit switch prevents a hyper-extension or a hypo-extension of said jack.
